(19) United States
(12) Patent Application Publication
(10) Pub. No.: US 2009/0163261 A1
(43) Pub. Date: Jun. 25, 2009

(54) SHOOTING GAME

(75) Inventor: Gordon Crompton, Broadstairs (GB)

Correspondence Address: BARNES & THORNBURG LLP, P.O. BOX 2786, CHICAGO, IL, 60690-2786, US

(73) Assignee: GAME CONCEPTS LTD., Broadstairs (GB)

(21) Appl. No.: 12/136,281

(22) Filed: Jun. 10, 2008

(30) Foreign Application Priority Data
Dec. 19, 2007 (GB) 0724766.1

(51) Int. Cl. A63F 9/24; A63F 13/00

(52) U.S. Cl. 463/5

(57) ABSTRACT

A shooting game uses items fired from shooter 4 towards screen 2. Moving targets 32 are displayed on screen 2, and impact of items 28 on targets 32 is detected. The screen image may represent a storyline that is changed depending on the targets hit.

There are a number of types of coin-operated games commonly found in arcades, pubs, clubs or elsewhere. Increasingly, such games are video games, but more traditional types of games such as fruit machines and coin pushers are also widespread. Such games are operated by coins or tokens—the term “token” will be used to refer to either coins or tokens. The choice between coins or tokens is often determined by local law.

A small number of games include some form of shooting mechanism. One such game is described in U.S. Pat. No. 6,811,494. In this game, there are a number of targets each having a transparent contact plate connected to an impact sensor. A display unit is fitted behind the transparent contact plate and displays the value of that target, the value changing throughout the game. A token shooting mechanism is used to shoot tokens towards the targets—each target that is hit score points to the value displayed behind the target.

There remains a need for innovation and variety in amusement games.

According to the invention there is provided a game according to claim 1.

By providing continually moving targets the player's interest in the game can be considerably enhanced compared to the game described in U.S. Pat. No. 6,811,494.

In particular, by using a screen it is possible to allow a full story to unfold, presented on the screen, and allow the shots of tokens against the screen to determine the game play, allowing the possibility of different story lines depending on the shots. For example, a game might involve two doors presented on the screen—the user shoots a token against the desired door to progress through that door and hence totally change the gameplay.

Further, the mechanism allows a variety of targets of different sizes to be presented.

For a better understanding of the invention, embodiments will be described, purely by way of example, with reference to the accompanying drawings, in which:

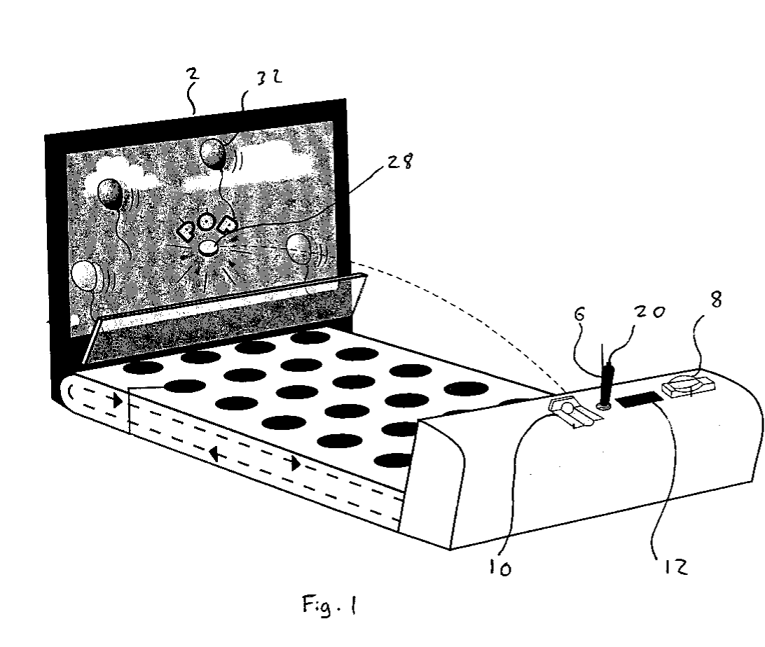

FIG. 1 shows a perspective view of a first embodiment of the invention;

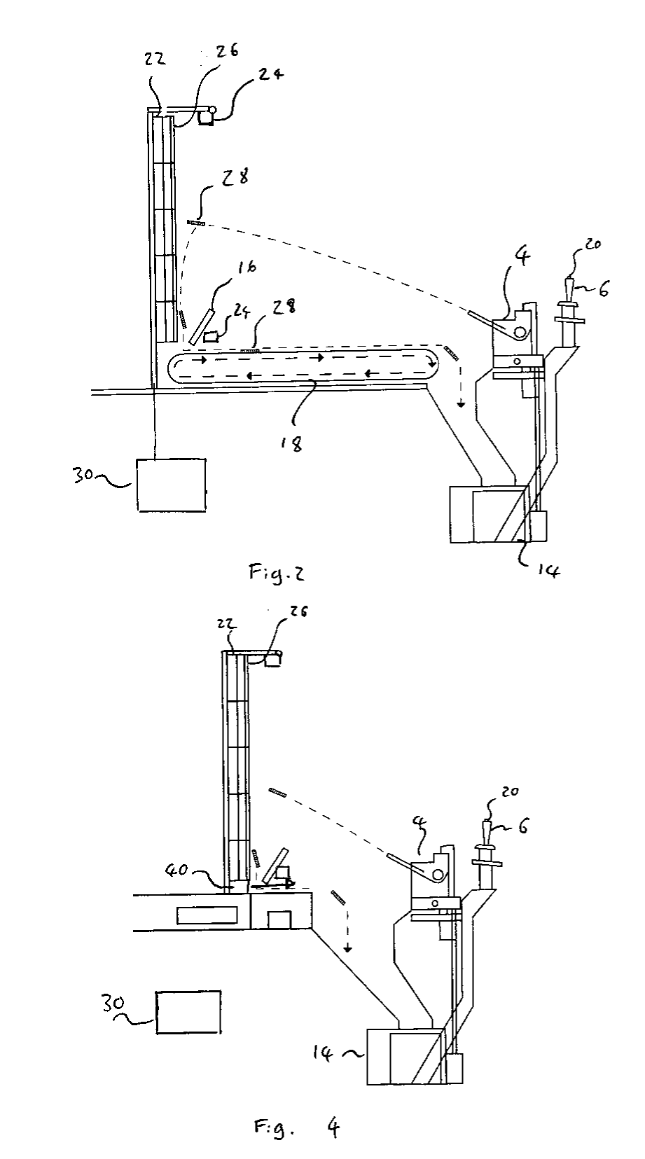

FIG. 2 shows a side view of the first embodiment;

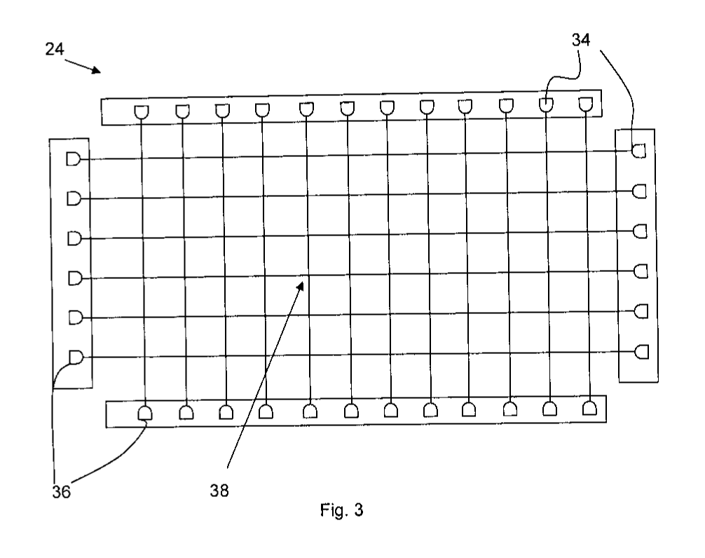

FIG. 3 shows a front view of the first embodiment; and

FIG. 4 shows a side view of a second embodiment of the invention.

The same or similar components are given the same reference numerals in the different embodiments and the description relating thereto is not repeated. The drawings are schematic and not to scale.

Referring to FIGS. 1 to 3, a games machine according to the first embodiment includes a display screen 2, a token shooter 4, a joystick 6 for controlling the aim of the token shooter 4, first coin entry 8, second coin entry 10, and credit display 12.

Tokens 28 input into either token entry 8, 10 are passed to hopper 14. The games machine also includes a collection bar 16 arranged adjacent to and in front of the lower side of the screen and a belt 18 which is arranged to collect tokens after impact on the screen or indeed tokens that have missed the machine and return them to hopper 14. In use, the belt is driven as indicated in FIGS. 1 and 2 with the top surface moving from screen 2 towards the token shooter 4.

The first token entry 8 is a single token entry of conventional type. The second coin entry 10 is intended to accept multiple tokens rapidly to allow rapid play of the game. In some arrangements, the first token entry may be a multiple coin entry arranged to accept coins of multiple values. In this case, coins input into the first token entry 8 may be stored in a separate cash box (not shown) and not passed to hopper 14.

A fire button 20 is provided on the top of the joystick 6.

The display screen 2 includes a conventional flat display 22. A transparent protection membrane 26 is included as the front part of the display 22. This protects the flat display 22.

In front of the display 22 and spaced from it is provided an infra-red detection system 24 illustrated in more detail in FIG. 3, in front view, i.e. looking towards the screen. In general terms, a grid of horizontal and vertical infra-red beams are provided in front of the screen. Interruptions in the beams are detected and used to locate the impact of a token on the screen.

Infra-red sources 34 are arranged along two edges of the screen and detectors 36 are arranged on opposite edges. The infra-red sources 34 emit light in the form of lines across the screen as a grid 38 and the detectors detect the light. As a token passes through the grid, it interrupts the lines of the grid which is detected in controller 30 (FIG. 2).

In the embodiment shown in FIGS. 1 to 3, the infra-red grid is spaced in front of the screen by 20 mm to 60 mm, preferably around 40 mm. By spacing the infra-red grid from the screen in this way, an improved detection accuracy is obtained. This is because by spacing the grid from the screen there is an increased time for detecting the token, which improves reliability. Such reliability can be very important in games of chance.

A controller 30 which detects the intersection of the token and the infra-red grid conveniently detects when two signals are very close together and removes one of the signals to avoid a token being detected twice as it passes towards the screen and then bounces back. A rapid speed recognition is required, wherein the detection takes place at lest once every fraction of a second. In the embodiment, detection takes place more frequently than once every 0.1 s.

Initial designs of the games machine described used a touch screen instead of an infra-red detection system. However, very high reliability of the detection of items hitting the screen is required for commercial games playing applications where consumers are paying to play the game. Failure to detect an item hitting the screen can cause, at least, significant consumer annoyance. Unfortunately, there are limits to the reliability of conventional touch screen technology, especially when used in an application with fast moving tokens or similar instead of the intended use of most commercial touch screens of picking up the slow pressure of a finger or stylus on the screen.

The use of the infra-red detection system as described significantly increased the detection accuracy compared with a touch screen system.

The machine is controlled by the controller 30 which is programmed to cause targets 32, here represented by balloons, to be displayed on the display 22. The targets move about the display.

The controller 30 counts the coins input into either coin entry 8, 10 and causes credit display 12 to display the credit. The controller directs the token shooter 4 under control of joystick 6 and shoots a single token off each time the user actuates fire button 20 assuming that the user has sufficient credit available.

After shooting each coin, the controller detects the location of token impact on the display 2 using the infra-red detection system 24 and compares the location of each target with the location of the token impact.

In the event that the token misses all targets, no further action is taken. When the controller detects a token hitting the target, it causes the display to display a video sequence. In the example, the targets 32 are represented by balloons and the video sequence is a video of a popping balloon displayed at the target location as illustrated in FIG. 1.

In the event of a the token hitting the target, tokens may be paid back to the player or tickets issued as required.

An elevator hopper or bucket system may be used to feed tokens from hopper 14 to the token shooter 4.

Experiments by the inventor have demonstrated a high reliability of detection of tokens on the screen using the approach described.

In a second embodiment, illustrated in FIG. 4, the belt 18 is omitted and replaced by pusher 40 which sweeps across the field to return tokens to the hopper 14.

In either case, the programs in the controller may be arranged to display video sequences on the display screen, sequences of still images or combinations. The targets may be integrated into the video or still images. The video may be used to tell a story in the gameplay. Some still images or video frames may include no targets at all, and targets may be displayed on the screen only intermittently.

The controller may include a number of different video sequences or still images, and when a token is detected to hit a target, the identity of the target and/or time that the target is hit or even the exact location that the target is hit may be used to choose which video sequence is displayed next.

Audio is conveniently integrated into the video or provided separately with the still images.

In this way, the targets hit may be used to change the story line presented by the video and/or still images. The targets may represent doors, different paths, or different people, and the storyline continues in a different way depending on which target is shot, which may indicate a different door or path being taken in the story, or a different person either being shot or simply interacted with. In such story-based embodiments, prizes may be dispensed with altogether, there may be a prize for successfully reaching one or more possible endings of the story or not others, or prizes may be issued for hitting certain targets during the story.

In an alternative arrangement, the same approach as in the embodiment of FIGS. 1 to 3 is adopted except that the items that are shot in the game are not tokens but other items such as balls, for example ping pong balls.

The same improved detection arrangement described above with regard to tokens may be used with such other items. For example, when arranging the grid for a ping-pong ball, the grid may be placed in front of the screen at a distances of 30% to 100% of the diameter of the ping pong ball, preferaly 45% to 75%. In an embodiment, a distance of 60% was used.

Further modifications may be made. For example, many different types of target may be displayed and in many arrangements multiple different targets of different values are provided. The movement patterns of targets on the screen may be varied.

Instead of smooth movement from one location to the other, targets may be removed and replaced by other targets at other locations.

Many different storylines are possible.

1. A token operated game, comprising:
a screen display;
a shooter for shooting items towards the screen display;
a location detecting means at the screen display for detecting the location on the display at which the items impact the display; and
a controller arranged to display targets on the screen display at locations that are not fixed, to move targets to different locations on the screen display and/or to present targets at different locations, and to compare the target locations on the screen with the detected location on the display to detect items impacting the targets;
wherein the location detecting means comprises a means for forming an infrared grid pattern over the front of the screen and a means for detecting interruptions in the infrared grid pattern to detect items impacting the screen.

2. A token operated game according to claim 1 wherein the infrared-grid pattern is spaced from the front of the screen by 20 mm to 60 mm.

3. A token operated game according to claim 1, wherein
the controller stores a plurality of different game sequences including still or moving images for display and at least one target, and
the controller is arranged to select one of the plurality of different game sequences and displays the one of the plurality of different game sequences on the display depending on which target location has been hit by an item.

4. A token operated game according to claim 1 wherein the display screen comprises a protective membrane on the front surface of the screen.

5. A token operated game according claim 4 further comprising a belt for returning items shot from the shooter back to the hopper.

6. A token operated game according to claim 1 wherein the items shot are tokens.

7. A token operated game according to claim 6 further comprising a pusher for returning tokens shot from the token shooter back to the hopper

8. A token operated game according to claim 1 wherein the items shot are balls.

9. A token operated game according to claim 1 wherein the controller is arranged to display a special target sequence at the detected target when the controller detects the impact of a token on a target.

10. A method of operating a shooting game, comprising:
displaying targets on a screen display at locations that are not fixed;
shooting items towards the screen display;
detecting the location where items hit the screen display by detecting interruptions in an infra-red grid pattern in front of the screen to detect items impacting the screen; and
comparing the target locations on the screen with the detected location on the display to detect items impacting the targets; and
select one of a plurality of different game sequences and displaying the selected one of a plurality of different game sequences on the display depending on which target location has been hit by an item.
